(19) United States
(12) Patent Application Publication
(10) Pub. No.: US 2011/0121959 A1
(43) Pub. Date: May 26, 2011

(54) INSTRUMENT DRIVER

(76) Inventors: Yousuke Maruyama, Niigata (JP); Masaki Yamazoe, Niigata (JP); Miroru Takebe, Niigata (JP); Osamu Shima, Niigata (JP)

(21) Appl. No.: 13/055,655

(22) PCT Filed: Jul. 7, 2009
(86) PCT No.: PCT/JP2009/062357

§ 371 Date: Jan. 24, 2011

(30) Foreign Application Priority Data
Jul. 24, 2008 (JP) 2008-190915

(51) Int. Cl. B60Q 1/00

(52) U.S. Cl. 340/438

(57) ABSTRACT

An instrument driver is provided in which a radical new representation can be used in presentation operation to improve marketability and design. The instrument driver includes an instrument 2 indicating vehicle information by turning of a pointer on a display plate and first and second illuminating means 2d and 2e for illuminating the instrument with different illumination colors. Control means 1 and 2a is included which causes the instrument 2 to perform presentation operation different from normal display operation in response to an input of a predetermined start signal and gradually changes at least brightness of the first illuminating means 2d and brightness of the second illuminating means 2e at different times as the presentation operation. The start signal is an input for turning on or an input for turning off a power source switch.

### RELATED APPLICATIONS

This application is the U.S. National Phase under 35 U.S.C. §371 of International Application No. PCT/JP2009/062357, filed on Jul. 7, 2009, which in turn claims the benefit of Japanese Application No. 2008-190915, filed on Jul. 24, 2008, the disclosures of which Applications are incorporated by reference herein.

### TECHNICAL FIELD

The present invention relates to an instrument driver in which a pointer is turned on a display plate to indicate vehicle information.

### BACKGROUND ART

A known instrument for vehicle displaying various types of information about a vehicle (hereinafter referred to as vehicle information) such as vehicle speed, engine RPM, water temperature, and oil pressure has a pointer display type instrument in which a pointer is mounted on a driving body and the pointer is turned on a display plate to indicate a measured amount representing the vehicle information, for example. This type includes a combination meter containing a speed meter or a rotation meter and a fuel meter housed in a case body, a so-called additional meter including a single analog instrument body housed in a case to monitor the vehicle information independently of the combination meter, and the like.

A radical new design is desired in such an instrument for vehicle, and a known instrument performs presentation operation (non-display operation) different from the display of the vehicle information in response to an input for turning on or off an ignition switch (power switch) of a vehicle. Examples of the presentation operation includes the operation of turning a pointer from a zero position to the maximum marking position along the scale of a display plate and then returning the pointer to the zero position or the use of a dedicated illumination light source for each of the pointer and the display plate to light up the illumination light sources at different times in response to turn-on of an IGN switch or to change the brightness levels of the illumination light sources gradually. Such an instrument for vehicle is disclosed in Patent Documents 1 and 2, for example.

### Prior Art Document

### Patent Documents

Patent Document 1: JP-A-2004-245755

Patent Document 2: JP-A-2004-325324

### DISCLOSURE OF THE INVENTION

### Problems that the Invention is to Solve

The presentation operation, however, has always required a radical new version, and further improvements have been needed in a representation method using the illuminating means.

The present invention has been made in view of the abovementioned problem, and it is an object thereof to provide an instrument driver in which a radical new representation can be used in presentation operation to improve marketability and design.

### Means for Solving the Problems

To solve the abovementioned problem, the present invention is characterized by an instrument driver including an instrument indicating vehicle information by turning of a pointer on a display plate and first and second illuminating means for illuminating the instrument with different illumination colors, wherein control means is included which causes the instrument to perform presentation operation different from normal display operation in response to an input of a predetermined start signal and gradually changes at least brightness of the first illuminating means and brightness of the second illuminating means at different times as the presentation operation.

The present invention is characterized in that the control means gradually increases the brightness of the first illuminating means to the maximum and then gradually reduces the brightness, and gradually increases the brightness of the second illuminating means to the maximum during the reduction of the brightness of the first illuminating means as the presentation operation.

The present invention is characterized in that the control means turns the pointer during the change of at least one of the brightness of the first illuminating means and the brightness of the second illuminating means as the presentation operation.

The present invention is characterized in that the start signal is an input for turning on or an input for turning off a power source switch.

The present invention is characterized in that the first and second illuminating means illuminate at least one of the pointer and the display plate.

The present invention is characterized by including first control means as the control means for transmitting presentation operation data as serial data in response to an input of the start signal and second control means as the control means for receiving the serial data and causing the instrument to perform the presentation operation in response to the serial data.

### ADVANTAGE OF THE INVENTION

The present invention relates to an instrument driver in which a pointer is turned on a display plate to indicate vehicle information, and a radical new representation can be used in presentation operation to improve marketability and design.

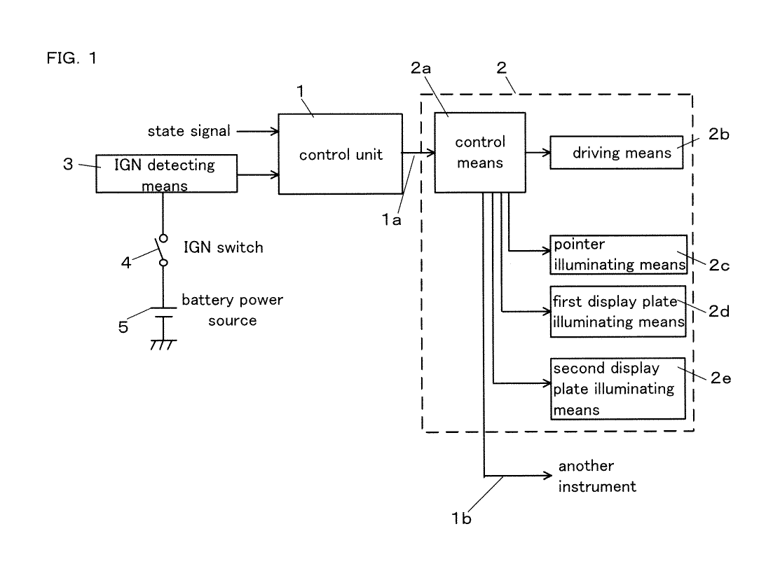

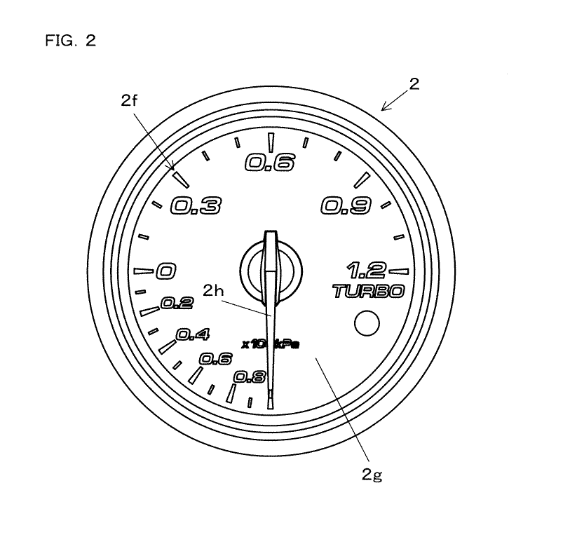

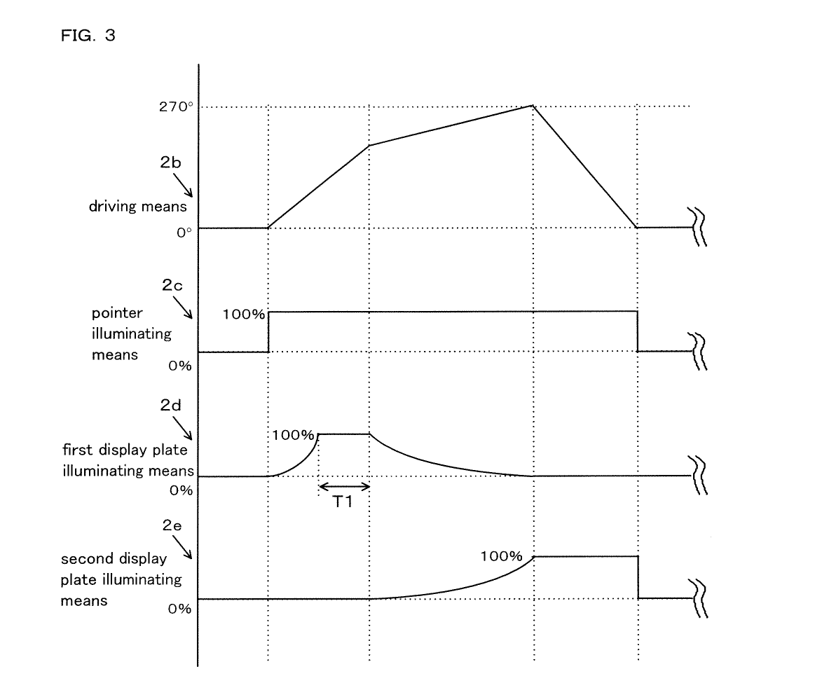

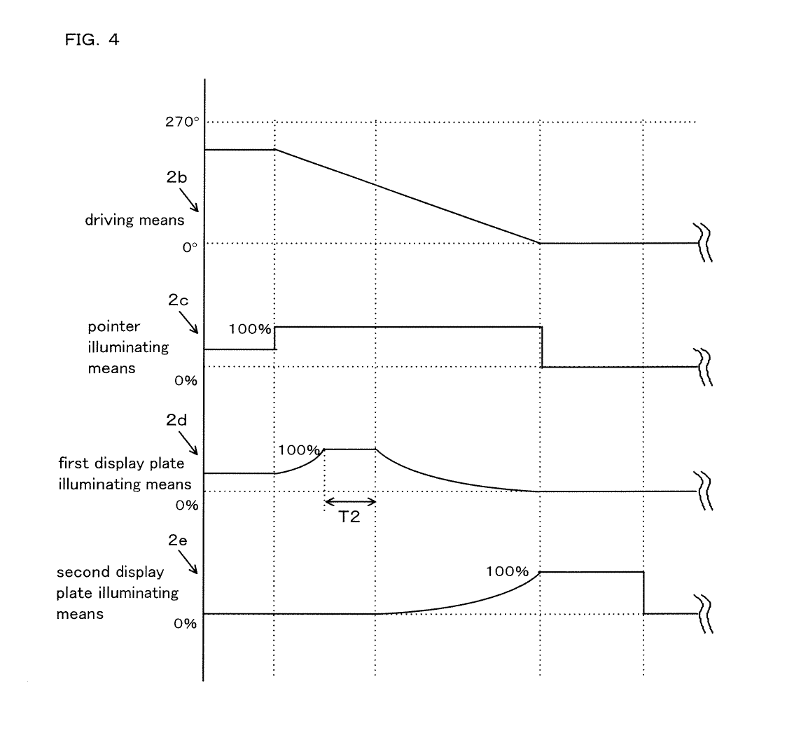

### BRIEF DESCRIPTION OF THE DRAWINGS

[FIG. 1] A diagram showing an analog meter of an instrument driver which is an embodiment of the present invention.

[FIG. 2] A diagram showing the electric configuration of the instrument driver.

[FIG. 3] A diagram showing a processing method in control means of the instrument driver.

[FIG. 4] A diagram showing a processing method in the control means of the instrument driver.

### BEST MODE FOR CARRYING OUT THE INVENTION

Description will hereinafter be an embodiment in which the present invention is applied to an instrument driver where it is assumed that a plurality of instruments for vehicle are placed. The overall configuration of the instrument driver is described with reference to FIGS. 1 and 2. As shown in FIG. 1, the instrument driver is mainly formed of a control unit (first control means) 1, an analog meter (instrument) 2, and IGN (ignition) detecting means 3.

The control unit 1 is formed of a microcomputer, and consists of an A/D converting portion which receives an input of each state signal representing vehicle information, a CPU which executes a predetermined processing program, a ROM which has the processing program and the like stored therein, a RAM which has data or the like processed by the CPU stored temporarily therein, a parallel/serial converting portion (P/S converting portion) which converts parallel data into serial data, a storage portion which is formed of an EEPROM or a backup RAM having various settings stored therein in a non-volatile manner, and a transmitting portion which transmits the serial data at predetermined intervals. Upon reception of an input of each of the state signals representing the vehicle information, the control unit 1 performs predetermined computation processing in response to each of the state signals to calculate each measurement data of the vehicle information. In a normal operation mode, the control unit 1 converts parallel data which is a model code for identifying the model of the instrument and each of the measurement data into serial data and transmits the data to control means 2a, later described, of the analog meter 2 via a wiring member 1a. Upon reception of an input of a detection signal for turning on the IGN switch 7 from the IGN detecting means 3 as a predetermined start signal, the control unit 1 transmits initial operation data (presentation operation data) for causing the analog meter 2 to perform initial operation (presentation operation) different from normal display operation of the vehicle information to the control means 2a as serial data.

The analog meter 2 is an analog instrument for vehicle which has the control means (second control means) 2a, driving means 2b, pointer illuminating means 2c, first display plate illuminating means (first illuminating means) 2d, and second display plate illuminating means (second illuminating means) 2e, and also has a display plate 2g on which an indicator portion 2f for vehicle information is formed through printing and a pointer 2h pointing to the indicator portion 2f. FIG. 2 shows a manifold pressure indicator (turbo meter) as the outer appearance of the analog meter 2.

The control means 2a is formed of a microcomputer and receives the serial data transmitted by the control unit 1 to control the driving means 2b, the pointer illuminating means 2c, the first display plate illuminating means 2d, and the second display plate illuminating means 2e based on the serial data. The control means 2a includes a connection portion connectable to another instrument via a wiring member 1b such that a plurality of instruments for vehicle can be connected to each other to perform the communication of the serial data. The control means 2a has an initial operation function, later described in detail, of controlling the driving means 2b, the pointer illuminating means 2c, the first display plate illuminating means 2d, and the second display plate illuminating means 2e based on the initial operation data received as the serial data to perform the initial operation.

The driving means 2b is formed of a stepping motor performing step angle operation, and drives and causes the pointer 2h through a rotation axis (not shown) to point to the indicator portion 2f. A user can know a change in the measurement amount of the vehicle information by comparing and reading the pointer 2h and the indicator portion 2f.

The pointer illuminating means 2c is formed of a light emitting element such as an LED, and illuminates an indicating portion of the pointer 2h with illumination light.

The first and second display plate illuminating means 2d and 2e illuminate the display plate 2g with illumination light having different light emission colors, and the illumination light passes through and illuminates the indicator portion 2f. The user can switch between light-up/light-out of the first and second display plate illuminating means 2d and 2e by operating an operation switch to select one of the two light emission colors in normal operation. In the present embodiment, the first display plate illuminating means 2d emits illumination light of red color, while the second display plate illuminating means 2e emits illumination light of blue color.

The IGN detecting means 3 detects the transition from off state to on state and the transition from on state to off state of the IGN switch 4 of the vehicle. Upon detection of the on state or off state of the IGN switch 4, the IGN detecting means 3 outputs a detection signal to the control unit 1. The on state of the IGN switch 4 may be any of the transition from the off state of the IGN switch 4 to the on state of an accessory power source, the transition from the off state of the IGN switch 4 to the on state of engine start, and the transition from the on state of the accessory power source to the on state of engine start. The IGN switch 4 has one end connected to a battery power source 5 of the vehicle and the other end connected to the IGN detecting means 3.

The portions described above constitute the instrument driver.

Next, description will be made of the initial operation function of the control unit 1 and the control means 2a in the instrument driver with reference to FIG. 3. It is assumed that the analog meter 2 supports angles from 0° to 270° indicated by the pointer 2h and that the origin position of the pointer 2h corresponds to the minimum marking position.

Upon detection of an on state (input for turn-on) of the IGN switch 4 as the start signal via the IGN detecting means 3, the control unit 1 transmits the initial operation data as the serial data. In response to the received initial operation data, the control means 2a outputs a driving signal for performing the initial operation to the driving means 2b, the pointer illuminating means 2c, the first display plate illuminating means 2d, and the second display plate illuminating means 2e.

FIG. 3 is a timing chart showing a control method of the driving means 2b, the pointer illuminating means 2c, the first display plate illuminating means 2d, and the second display plate illuminating means 2e in the initial operation. In the initial operation, the control means 2a outputs the driving signal to the driving means 2b to start turning of the pointer 2h mounted on the driving means 2b from the minimum marking position (at an indication angle of 0°) toward the maximum marking in the indicator portion 2f. The control means 2a lights up the pointer illuminating means 2c for illuminating the pointer 2h with the maximum brightness (100% brightness) simultaneously with the start of the turning of the pointer 2h toward the maximum marking. The control means 2a controls the lighting of the first display plate illuminating means 2d for illuminating the display plate 2g to cause a gradual change from the light-out state (0% brightness) to the maximum brightness (100% brightness) simultaneously with the start of the turning of the pointer 2h toward the maximum marking. After the lapse of a time T1 after the first display plate illuminating means 2d reaches the maximum brightness, the control means 2a controls the lighting of the first display plate illuminating means 2d to cause a gradual change from the maximum brightness to the light-out state. Next, the control means 2a controls the lighting of the second display plate illuminating means 2e to cause a gradual change from the light-out state to the maximum brightness simultaneously with the start of the change of the brightness of the first display plate illuminating means 2d toward the light-out state. After the control means 2a causes the pointer 2h to reach the maximum marking position (at an indication angle of 270°), the control means 2a turns the pointer 2h in the minimum marking direction in the indicator portion 2f. The control means 2a performs the lighting control such that the first display plate illuminating means 2d is in the light-out state and the second display plate illuminating means 2e has the maximum brightness at the time when the pointer 2h reaches the maximum marking position. The control means 2a controls the driving means 2b such that the pointer 2h reaches the minimum marking position. After the pointer 2h reaches the minimum marking position, the control means 2a turns out the pointer illuminating means 2c and the second display plate illuminating means 2e and finishes the initial operation to transition to the normal display operation of the vehicle information. In the display operation of the vehicle information, one of the first and second display plate illuminating means 2d and 2e that is selected as the illumination color is lit up.

Since the processing described above is performed by the control unit 1 and the control means 2a, the instrument driver can perform the novel presentation operation in which the first display plate illuminating means 2d and the second display plate illuminating means 2e are changed gradually in brightness at different times in the initial operation to change smoothly the illumination color for the display plate 2g. Such presentation operation allows the indicator portion 2f of red color and the indicator portion 2f of blue color to be visually recognized as if they emerged alternately, and is a radical new illumination representation different from mere brightness changes or momentary switch of illumination colors. The changes in the illumination colors can be represented more clearly by gradually increasing the brightness of the first display plate illuminating means 2d to the maximum and then gradually reducing the brightness, and gradually increasing the brightness of the second display plate illuminating means 2e to the maximum during the reduction of the brightness of the first display plate illuminating means 2d. In addition, the pointer 2h can be turned within a predetermined range in association with the brightness changes of the first and second display plate illuminating means 2d and 2e to improve the appearance of the initial operation.

For the presentation operation in the present embodiment, a finishing operation may be performed by using an input for turning off the IGN switch 4 as the start signal. FIG. 4 is a timing chart showing an example of a control method of the driving means 2b, the pointer illuminating means 2c, the first display plate illuminating means 2d, and the second display plate illuminating means 2e in the finishing operation. In FIG. 4, it is assumed that the red color illumination by the first display plate illuminating means 2d is selected as the illumination color for the display plate 2g in the normal display operation.

Upon detection of an off state (input for turn-off) of the IGN switch 4 as the start signal via the IGN detecting means 3, the control unit 1 transmits finishing operation data for performing the finishing operation as the serial data. In response to the received finishing operation data, the control means 2a outputs a driving signal for performing the finishing operation to the driving means 2b, the pointer illuminating means 2c, the first display plate illuminating means 2d, and the second display plate illuminating means 2e.

As shown in FIG. 4, in the finishing operation, the control means 2a outputs a driving signal to the driving means 2b of the analog meter 2 to start turning of the pointer 2h from the current indicating position representing the vehicle information toward the minimum marking in the indicator portion 2f. The control means 2a lights up the pointer illuminating means 2c for illuminating the pointer 2h with the maximum brightness simultaneously with the start of the turning of the pointer 2h toward the minimum marking. The control means 2a controls the lighting of the first display plate illuminating means 2d for illuminating the display plate 2g to cause a gradual change to the maximum brightness simultaneously with the start of the turning of the pointer 2h toward the maximum marking. After the lapse of a time T2 after the first display plate illuminating means 2d reaches the maximum brightness, the control means 2a controls the lighting of the first display plate illuminating means 2d to cause a gradual change from the maximum brightness to the light-out state. Next, the control means 2a controls the lighting of the second display plate illuminating means 2e to cause a gradual change from the light-out state to the maximum brightness simultaneously with the start of the change of the brightness of the first display plate illuminating means 2d toward the light-out state. The control means 2a performs the lighting control such that the first display plate illuminating means 2d is in the light-out state and the second display plate illuminating means 2e has the maximum brightness at the time when the pointer 2h reaches the minimum marking position. The control means 2a controls the driving means 2b such that the pointer 2h reaches the minimum marking position. The control means 2a turns out the pointer illuminating means 2c simultaneously with the arrival of the pointer 2h at the minimum marking position, and then turns outs the second display plate illuminating means 2e with a time difference, and finishes the finishing operation to stop the driving of the analog meter 2.

Since the processing described above is performed by the control unit 1 and the control means 2a, the instrument 1 for vehicle can perform the novel presentation operation in which the first display plate illuminating means 2d and the second display plate illuminating means 2e are changed gradually in brightness at different times in the finishing operation to change smoothly the illumination color for the display plate 2g.

The present invention is not limited to the abovementioned embodiment, and the present invention is applicable to demonstration operation in which turning operation is performed within a predetermined range for exhibition.

In the present embodiment, the first and the second display plate illuminating means 2d and 2e for illuminating the display plate 2g as the first and second illuminating means are changed in brightness at different times. However, the present invention may include first and second pointer illuminating means for illuminating the pointer 2h as first and second illuminating means such that the first and second pointer illuminating means having different illumination colors are changed in brightness at different times to change the illumination light colors gradually. The first and second illuminating means in the present invention may provide a single illumination color as in the present embodiment, or may illuminate the instrument with a plurality of illumination colors.

The presentation operation of the present invention is not limited to the present embodiment, and time-different lighting and time-different extinguishment maybe combined in a predetermined order.

### INDUSTRIAL APPLICABILITY

The present invention is widely applicable to the instrument driver in which the pointer is turned on the display plate to indicate the vehicle information.

### DESCRIPTION OF REFERENCE NUMERALS AND SIGNS

1 control unit (first control means)
2 analog meter (instrument)
2a control means (second control means)
2b driving means
2c pointer illuminating means
2d first display plate illuminating means (first illuminating means)
2e second display plate illuminating means (second illuminating means)
2f indicator portion
2g display plate
2h pointer
3 IGN detecting means

1. An instrument driver comprising an instrument indicating vehicle information by turning of a pointer on a display plate and first and second illuminating means for illuminating the instrument with different illumination colors,
wherein control means is included, the control means causing the instrument to perform presentation operation different from normal display operation in response to an input of a predetermined start signal and gradually changing at least brightness of the first illuminating means and brightness of the second illuminating means at different times as the presentation operation.

2. The instrument driver according to claim 1, wherein the control means gradually increases the brightness of the first illuminating means to the maximum and then gradually reduces the brightness, and gradually increases the brightness of the second illuminating means to the maximum during the reduction of the brightness of the first illuminating means as the presentation operation.

3. The instrument driver according to claim 1, wherein the control means turns the pointer during the change of at least one of the brightness of the first illuminating means and the brightness of the second illuminating means as the presentation operation.

4. The instrument driver according to claim 1, wherein the start signal is an input for turning on or an input for turning off a power source switch.

5. The instrument driver according to claim 1, wherein the first and second illuminating means illuminate at least one of the pointer and the display plate.

6. The instrument driver according to claim 1, further comprising first control means as the control means for transmitting presentation operation data as serial data in response to an input of the start signal and second control means as the control means for receiving the serial data and causing the instrument to perform the presentation operation in response to the serial data.
